(19) United States
(12) Patent Application Publication
(10) Pub. No.: US 2024/0167731 A1
(43) Pub. Date: May 23, 2024

(54) HEAT SUPPLY DEVICE USING UNDERGROUND DRY HEAT SOURCE AND HEAT SUPPLY METHOD

(71) Applicant: Shandong University of Science and Technology, Qingdao (CN)

(72) Inventors: Huizhen LIANG, Qingdao (CN); Xiukun JIANG, Qingdao (CN); Yikun YUAN, Qingdao (CN); Chengzhen LI, Qingdao (CN); Jian MA, Qingdao (CN)

(21) Appl. No.: 18/058,380

(22) Filed: Nov. 23, 2022

(51) Int. Cl. F24T 10/17

(52) U.S. Cl. CPC F24T 10/17; F24T 2010/53

(57) ABSTRACT

The present disclosure provides a heat supply device using an underground dry heat source. The heat supply device comprises a cold water supply device, a hot water suction pump and a heat supply pipeline, wherein the cold water supply device is arranged on the ground and used for injecting cold water into the heat supply pipeline; the hot water suction pump is connected with the heat supply pipeline; and the heat supply pipeline comprises a vertical well conduction section and a horizontal well heating section. The present disclosure further provides a heat supply method using the heat supply device using an underground dry heat source. The heat supply method comprises the followings steps: S1, exploring the underground dry heat source; S2, measuring the heat conductivity coefficient of hot dry rock; S3, drilling a well; S4, determining the number of branch wells; and S5, arranging a heat supply device.

### TECHNICAL FIELD

The present disclosure relates to the technical field of underground heat energy utilization, in particular to a heat supply device using an underground dry heat source and a heat supply method.

### BACKGROUND

The earth is a huge thermal reservoir, and the hot dry rock in the underground heat source refers to the high-temperature rock mass buried deep underground. The temperature of the high-temperature rock mass is usually greater than 180° C., and the high-temperature rock mass contains little or no fluid. Generally speaking, the earth is the underground natural “boiler room” and is considered as an alternative clean energy with great strategic potentials. The hydrogeological environment experts of China Geological Survey thought that when the drilling depth reaches more than 2000 m, the temperature of the rock mass is generally high, and the temperature gradient is unusually obvious. The temperature can be increased by 7° C. at most when the depth is increased by 100 m. According to the calculation of the temperature increasing rate, it is estimated that the temperature can reach 260° C. when the drilling depth reaches about 4000 m underground, and the application prospect is very broad.

According to the data display of China Geological Survey, the total amount of hot dry rock resources with the depths of 3-10 km in Chinese mainland is 2.5×1025 joules (equivalent to 856 trillion tons of standard coal) and is 30 times of the total amount of oil, gas and coal resources in China.

At present, the development technology of hot dry rock resources mainly uses an enhanced geothermal system (EGS) to extract the heat inside the hot dry rock resources. The principle is as follows.

Firstly, a well (reinjection well) is drilled from the ground into the hot dry rock mass buried deep underground, and low-temperature water is injected into the stratum at high pressure. The high-pressure water can cause many cracks in the rock mass, or make the original cracks expand into larger cracks. With the continuous injection of low-temperature water, more and more cracks are generated, expanded and connected with each other, and finally an artificial underground hot water storage space is formed.

Secondly, several producing wells are drilled at reasonable positions away from the reinjection well. After the high-temperature water and steam are extracted from the stratum to the ground, the high-temperature water and steam are used for power generation and comprehensive utilization through heat exchange and ground circulation devices. The used warm water is injected into the underground hot dry rock mass through the reinjection well, so that the purpose of recycling is achieved.

The conditions of the stratum are complex, and the permeability and pore structure of different stratum are quite different. Therefore, this technology is complex, and a particularly high injection pressure is required to inject low-temperature water into the stratum, resulting in some phenomena such as low reinjection rate of low-temperature water, low reinjection amount and low recovery rate of high-temperature water. Moreover, the quality of injected water and produced water changes greatly, and special treatment technology is needed, so that the whole operation cost is greatly increased. At the same time, a series of problems such as land subsidence, even continuous decline of geothermal energy level, shortening of geothermal well life and insufficient utilization of geothermal energy resources may be caused.

### SUMMARY

The present disclosure aims to provide a heat supply device and method using an underground dry heat source capable of ensuring constant water quality and reducing water treatment process, so that the traditional heat tube technology is improved, and the energy loss in the heating, condensation, heat extraction and reheating processes is reduced.

The present disclosure provides a heat supply device using an underground dry heat source. The heat supply device comprises a cold water supply device, a hot water suction pump and a heat supply pipeline, wherein the cold water supply device is arranged on the ground and used for injecting cold water into the heat supply pipeline; the hot water suction pump is connected with the heat supply pipeline; and the heat supply pipeline comprises a vertical well conduction section and a horizontal well heating section.

Further, the heat supply pipeline further comprises a plurality of branch well heating sections respectively connected with the horizontal well heating section.

Further, the heat supply pipeline comprises an inner tube and an outer tube, the inner tube is arranged in the middle of the outer tube, and the inner tube is a hot water channel; and a cold water channel is formed between the inner tube and the outer tube, the cold water supply device injects cold water into the cold water channel, and the heated hot water is pumped out of the inner tube by the hot water suction pump.

Further, the heat supply device further comprises a cold water unidirectional flow control device, wherein the cold water unidirectional flow control device is in threaded connection with the outer tube;
the cold water unidirectional flow control device comprises a first sealing plug, a limiting baffle, a compression spring, a tube shoulder and supporting tubes; the first sealing plug sleeves the inner tube and is in clearance fit with the inner tube, and the first sealing plug and the supporting tubes are sealed by a conical sealing structure; the limiting baffle is welded with the supporting tubes as a whole and used for limiting the left-and-right torsion of the compression spring, and the limiting baffle is provided with a limiting piece and a flow port; the compression spring is arranged between the first sealing plug and the tube shoulder, and the tube shoulder is in threaded connection with the inner tube; and the supporting tubes are in threaded connection with the outer tube.

Further, the supporting tubes comprise a first supporting tube, a second supporting tube and a third supporting tube, the limiting baffle is welded on the second supporting tube, and the two ends of the second supporting tube are respectively welded and connected with the first supporting tube and the third supporting tube; and the bottom of the first supporting tube is in threaded connection with the outer tube, and the top of the third supporting tube is in threaded connection with the outer tube.

Further, the heat supply device further comprises a hot water constant temperature control device, wherein the hot water constant temperature control device is in threaded connection with the inner tube.

Further, the hot water constant temperature control device comprises a hollow fixed mount and a control tube joint; one side of the control tube joint is in threaded connection with the inner tube of the horizontal well heating section, the other side of the control tube joint is in threaded connection with the hollow fixed mount, and the hollow fixed mount is in threaded connection with the inner tube of the horizontal well heating section;
a push rod, a temperature control movable assembly and a sealing assembly are arranged in the control tube joint; one end of the push rod is connected with the hollow fixed mount, and the other end of the push rod is in clearance fit with the temperature control movable assembly; and the sealing assembly is connected with the temperature control movable assembly and is in threaded connection with the control tube joint.

Further, the temperature control movable assembly comprises a moving block and a central rod; one end of the push rod extends into the port of the moving block to form a clearance fit with the moving block; a cavity is formed in the interior of the moving block, the cavity is filled with paraffin, a telescopic rubber hose is arranged in the cavity, and a proper amount of compressed air is injected into the telescopic rubber hose; and one end of the central rod is in threaded connection with the moving block.

Further, the sealing assembly comprises a first memory spring, a second sealing plug baffle seat, a second sealing plug, a spring baffle seat, a second memory spring and a spring baffle; the first memory spring sleeves the central rod, the second sealing plug baffle seat is connected with the control tube joint, and the second sealing plug baffle seat and the second sealing plug are sealed by a baffle seat sealing ring; the spring baffle is welded with the second sealing plug, and the second sealing plug is in threaded connection with the central rod; one end of the second memory spring is installed in the spring baffle, and the other end of the second memory spring is connected with the spring baffle seat; and the spring baffle seat is in threaded connection with the control tube joint.

The present disclosure further provides a heat supply method using the heat supply device using an underground dry heat source, comprising the following steps:
S1, exploring the underground dry heat source: using a special heat source exploration tool to explore an underground dry heat source area;
S2, measuring the heat conductivity coefficient of hot dry rock: extracting samples from explored dry heat source rock strata, and experimentally testing the heat conductivity coefficient; and according to the measured heat conductivity coefficient of the dry heat source and the heat conductivity coefficient of the heat supply pipeline, calculating the heat required by unit mass of cold water to heat hot water to a certain temperature in combination with the temperature difference between cold water and hot water;
S3, drilling a well: according to the explored heat source area, determining the drilling depth, drilling a vertical well, and drilling a horizontal well section after reaching the dry-hot strata;
S4, determining the number of branch wells: according to the injection flow of cold water and the engineering size of the heat supply pipeline, determining the number and size of branch wells to be drilled by the calculated heat required by unit mass of cold water; and
S5, arranging the heat supply device: arranging the heat supply pipeline in the drilled well, placing the cold water supply device on the ground outside the well, and placing the hot water suction pump in the heat supply pipeline.

Compared with the prior art, the present disclosure has the beneficial effects that the horizontal well and the vertical well of the heat supply pipeline are combined to be applied to geothermal exploitation, and the heat transfer efficiency of the geothermal strata is improved. On the ground, the cold water supply device is used for supplying cold water for the heat supply pipeline at any time, and the hot water suction pump is used for pumping out hot water meeting the water temperature requirements after geothermal heating from the heat supply pipeline for domestic hot water and other fields, so that the constant water quality is ensured, the water treatment process is reduced, and the energy loss of the technologies such as heat tubes in the heating, condensation, heat extraction and reheating processes is reduced.

### BRIEF DESCRIPTION OF THE DRAWINGS

In order to illustrate the technical solutions in the embodiment of the present disclosure or in the prior art more clearly, the attached figures needing to be used in the embodiment or in the description in the prior art are simply described. Apparently, the embodiments in the following description are merely a part rather than all of the embodiments of the present disclosure. For trubber hose of ordinary skill in the art, under the premise of without contributing creative labor, other attached figures further can be obtained according to these attached figures.

FIG. 1 is a structural schematic diagram of a heat supply device using an underground dry heat source in the embodiment of the present disclosure.

FIG. 2 is a structural schematic diagram of a cold water unidirectional flow control device in the embodiment of the present disclosure.

FIG. 3 is a partial enlarged schematic diagram of part B in FIG. 2 in the present disclosure.

FIG. 4 is a partial enlarged schematic diagram of part A in FIG. 2 in the present disclosure.

FIG. 5 is a structural schematic diagram of a hot water constant temperature control device in the embodiment of the present disclosure.

FIG. 6 is a partial enlarged schematic diagram of part C in FIG. 5 in the present disclosure.

Reference signs in the attached figures:
1, cold water supply device; 2, outer tube; 3, inner tube; 4, hot water suction pump; 5, cold water channel; 6, hot water channel; 7, cold water unidirectional flow control device; 8, hot water constant temperature control device; 9, horizontal well heating section; 10, first branch well heating section; 11, second branch well heating section; 12, third branch well heating section; 13, fourth branch well heating section;
701, first sealing plug; 7011, conical sealing structure; 702, limiting baffle; 7021, limiting piece; 7022, flow port; 703, compression spring; 704, tube shoulder; 705, first supporting tube; 706, second supporting tube; 707, third supporting tube;
801, hollow fixed mount; 802, push rod; 803, paraffin; 804, moving block; 805, central rod; 806, first memory spring; 807, second sealing plug baffle seat; 8071, baffle seat sealing ring; 808, second sealing plug; 809, spring baffle seat; 810, second memory spring; 811, spring baffle; 812, telescopic rubber hose; 813, compressed air; and 814, control tube joint.

### DETAILED DESCRIPTION OF THE EMBODIMENTS

The following clearly and completely describes the technical scheme in the embodiments of the present disclosure with reference to the attached figures in the embodiments of the present disclosure. Apparently, the described embodiments are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

In the description of the present disclosure, it needs to be illustrated that the indicative direction or position relations of the terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise” and “anti-clockwise” are direction or position relations illustrated based on the attached figures, just for facilitating the description of the present disclosure and simplifying the description, but not for indicating or hinting that the indicated device or element must be in a specific direction and is constructed and operated in the specific direction, the terms cannot be understood as the restriction of the present disclosure.

In addition, the terms “first” and “second” are merely intended for a purpose of description, and shall not be understood as an indication or implication of relative importance or implicit indication of the number of indicated technical features. Therefore, a feature limited by “first” or “second” may include one or more features explicitly or implicitly. In the description of the present disclosure, the meaning of “a plurality of” means two or more unless expressly specifically defined otherwise. The terms such as “install”, “link” and “connect” should be generally understood, for example, the components can be fixedly connected, and also can be detachably connected or integrally connected; the components can be mechanically connected, and also can be electrically connected; the components can be directly connected, also can be indirectly connected through an intermediate, and can be communicated internally. For trubber hose skilled in the art, the specific meanings of the terms in the present disclosure can be understood according to specific conditions.

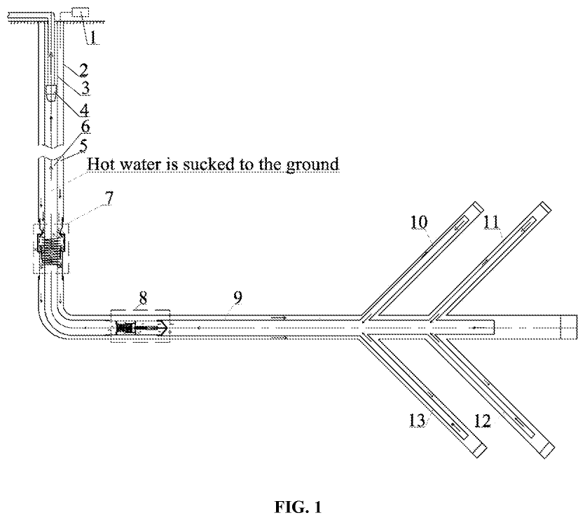

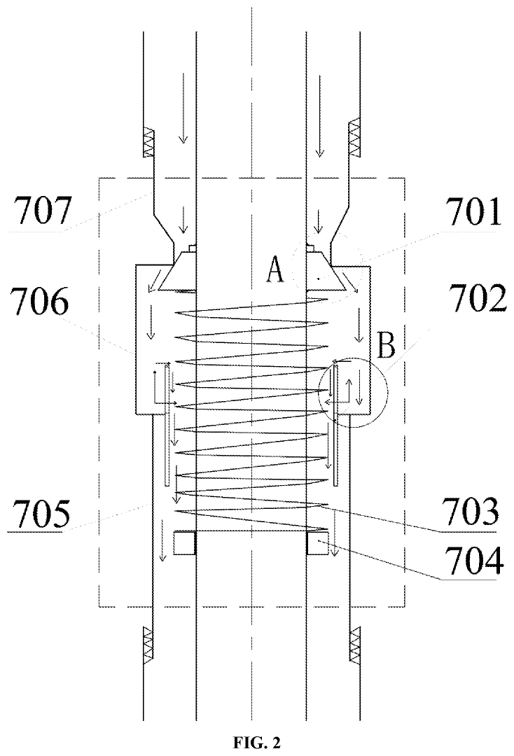

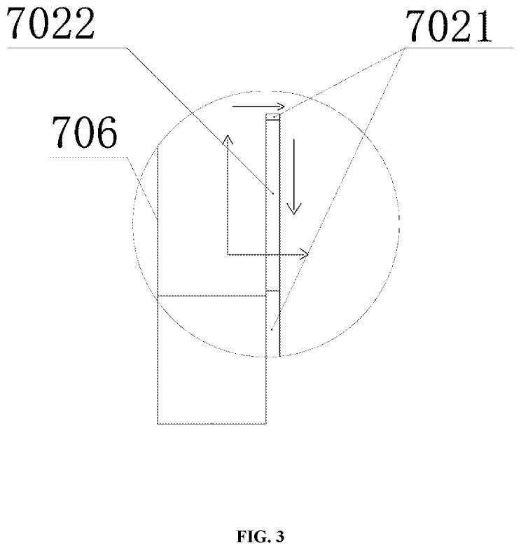

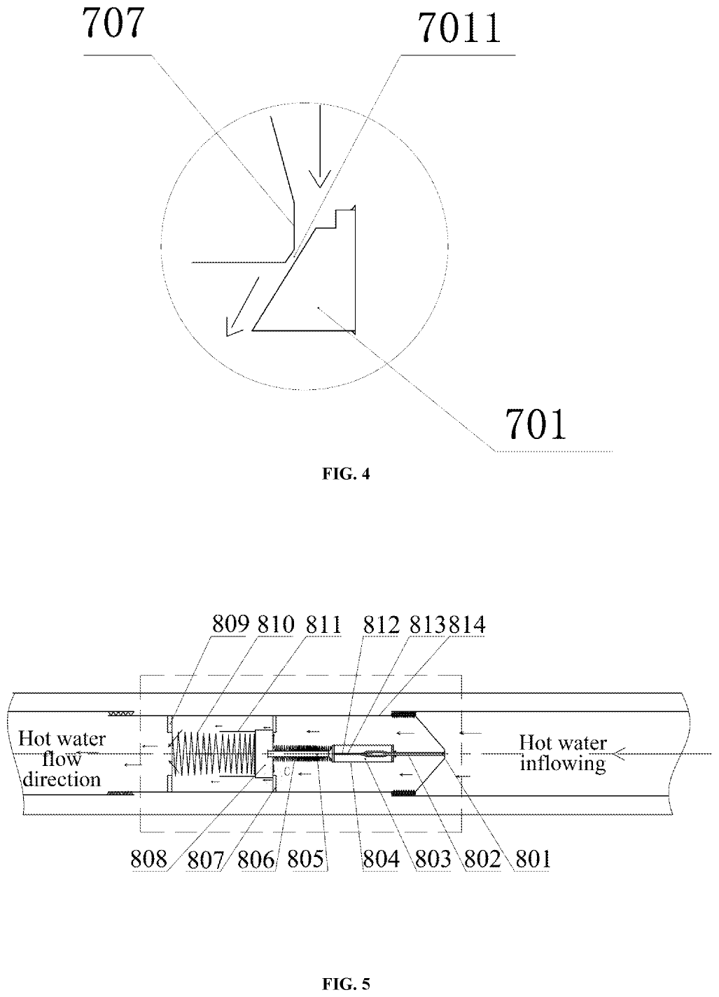

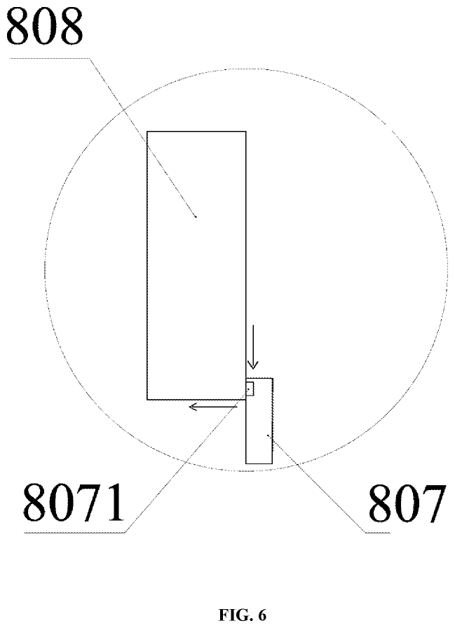

As shown in FIG. 1 to FIG. 6, the present disclosure provides a heat supply device using an underground dry heat source, comprising a cold water supply device 1, a hot water suction pump 4 and a heat supply pipeline. The cold water supply device 1 is arranged on the ground and used for injecting cold water into the heat supply pipeline. The hot water suction pump 4 is connected with the heat supply pipeline. The heat supply pipeline comprises a vertical well conduction section and a horizontal well heating section 9, and further comprises a plurality of branch well heating sections respectively connected with the horizontal well heating section 9. The length of the vertical well conduction section is preferably 3000-5000 m, the length of the horizontal well heating section 9 is preferably 500-1000 m, and the diameter of the heat supply pipeline is preferably 300 mm. In order to increase the heat transfer area of the dry heat source, a plurality of cluster branch wells are drilled, and the number and length of the branch wells are determined by the temperature and heat transfer coefficient of the dry heat source. As shown in FIG. 1, in the embodiment, the heat supply device is preferably provided with four branch well heating sections, namely a first branch well heating section 10, a second branch well heating section 11, a third branch well heating section 12 and a fourth branch well heating section 13.

The heat supply pipeline comprises an inner tube 3 and an outer tube 2, the inner tube 3 is arranged in the middle of the outer tube 2, and the inner tube 3 is a hot water channel 6. A cold water channel 5 is formed between the inner tube 3 and the outer tube 2, the cold water supply device 1 injects cold water into the cold water channel 5, and heated hot water is pumped out of the inner tube 3 by the hot water suction pump 4.

According to the water quality requirements of civil hot water in heating, greenhouse, domestic hot water, industrial drying or bathing, aquaculture, soil heating, dehydration and other different fields, low-temperature water is correspondingly treated on the ground. Cold water meeting the water quality requirements is injected into the cold water channel 5 between the outer tube 2 and the inner tube 3 by the cold water supply device 1. As the outer tube 2 and the inner tube 3 are made of heat transfer metal materials, high-temperature rock strata of the high-temperature dry heat source heat the cold water through the horizontal well heating section 9 and the branch well heating sections, and the horizontal well heating section 9 and the branch well heating sections of the high-temperature dry heat source heat the cold water through the high-temperature rock strata. The required hot water temperature is set according to different application fields. When the water temperature meets the requirements, the hot water is discharged to the vertical well conduction section through the inner tube 3 and finally pumped to the ground by the hot water suction pump 4 in different fields.

By adopting circulating devices in the cold and hot water heat supply pipeline, low-temperature water meeting the application conditions and working conditions of hot water can be directly injected into the dry-hot strata, and after heat is taken from the stratum, the hot water meeting the water temperature requirements is extracted to the ground, so that the constant water quality is ensured, and the water treatment process is reduced. At the same time, the energy loss of the technologies such as heat tubes in the heating, condensation, heat extraction and reheating processes is reduced.

After the cold water is injected into the high-temperature stratum through the cold water channel 5, heating is started. In order to prevent the heated water from flowing back from the cold water channel 5, a cold water unidirectional flow control device 7 is designed to ensure that the hot water can only flow upwards from the hot water channel 6 but cannot flow back from the cold water channel 5 to affect the injection of cold water.

The cold water unidirectional flow control device 7 comprises a first sealing plug 701, a limiting baffle 702, a compression spring 703, a tube shoulder 704 and supporting tubes. The first sealing plug 701 sleeves the inner tube 3 and is in clearance fit with the inner tube 3, so that the first sealing plug 701 is convenient to move up and down in the inner tube 3. The first sealing plug 701 and the supporting tubes are sealed by a conical sealing structure 7011, so that the structure can reduce the abrasion during sealing. The limiting baffle 702 is welded with the supporting tubes as a whole and used for limiting the left-and-right torsion of the compression spring 703, and the limiting baffle 702 is provided with a limiting piece 7021 and a flow port 7022. The compression spring 703 is arranged between the first sealing plug 701 and the tube shoulder 704, the tube shoulder 704 is used for supporting the compression spring 703, and the tube shoulder 704 is in threaded connection with the inner tube 3. The supporting tubes are in threaded connection with the outer tube 2. The annular flow port 7022 formed in the limiting baffle 702 is used as a channel for the cold water to flow downwards.

The supporting tubes comprise a first supporting tube 705, a second supporting tube 706 and a third supporting tube 707, the limiting baffle 702 is welded on the second supporting tube 706, and then the two ends of the second supporting tube 706 are respectively welded and connected with the first supporting tube 705 and the third supporting tube 707. The bottom of the first supporting tube 705 is in threaded connection with the outer tube 2, and the top of the third supporting tube 707 is in threaded connection with the outer tube 2. In order to withstand the stratum pressure and extend the service life of the supporting tubes, all the supporting tubes are made from N80 petroleum casing materials.

The cold water unidirectional flow control device 7 can ensure that cold water and hot water run in the respective channels, that is, cold water is injected from the cold water channel 5 and extracted from the hot water channel 6 after the stratum take heat, so that cold water and hot water are not mixed with each other.

The hot water heated by the four branch well heating sections of the dry heat source is collected into the horizontal well heating section 9 by the inner tube 3, and flows into the hot water constant temperature control device 8. The hot water constant temperature control device 8 is in threaded connection with the inner tube 3. The hot water constant temperature control device 8 comprises a hollow fixed mount 801 and a control tube joint 814. One side of the control tube joint 814 is in threaded connection with the inner tube 3 of the horizontal well heating section 9, the other side of the control tube joint 814 is in threaded connection with the hollow fixed mount 801, and the hollow fixed mount 801 is in threaded connection with the inner tube 3 of the horizontal well heating section 9.

A push rod 802, a temperature control movable assembly and a sealing assembly are arranged in the control tube joint 814. One end of the push rod 802 is connected with the hollow fixed mount 801, and the other end of the push rod is in clearance fit with the temperature control movable assembly so as to ensure that the temperature control movable assembly can move along the push rod. The sealing assembly is connected with the temperature control movable assembly, and can be in threaded connection with the control tube joint 814. When the temperature of the hot water reaches the set condition, the temperature control movable assembly is pushed by the push rod 802 until the sealing assembly is in an open state, so that the hot water continues to flow in the pipeline through the control tube joint 814.

The temperature control movable assembly comprises a moving block 804 and a central rod 805. One end of the push rod 802 extends into the port of the moving block 804 to form a clearance fit with the moving block 804. The moving block 804 is preferably made of copper. A cavity is formed in the interior of the moving block 804, the cavity is filled with paraffin 803, a telescopic rubber hose 812 is arranged in the cavity, and a proper amount of compressed air 813 is injected into the telescopic rubber hose 812 so as to ensure that the rubber hose is telescopic under the effect of external pressure. The right side of the telescopic rubber hose 812 sleeves the outer surface of the push rod 802 and is sealed with an adhesive tape, and one end of the central rod 805 is in threaded connection with the moving block 804. The telescopic rubber hose 812 filled with compressed air 813 is sealed firstly, then the cavity of the moving block 804 is filled with paraffin 803, and then the left end face of the moving block 804 is in threaded and sealing connection with the moving block 804. In practical application, the paraffin 803 is special paraffin, that is, according to the different hot water temperatures, the components contained in the paraffin can be adjusted, and the changes of the components can make the melting points of the paraffin different, so that it is ensured that the temperature control movable assembly can be turned on at different hot water temperatures and perform temperature control.

After the hot water reaches a set temperature, the temperature control movable assembly is turned on to output hot water and replenishment cold water, and heating and temperature control of the cold water is continued, so that dynamic balance and temperature control are maintained.

The sealing assembly comprises a first memory spring 806, a second sealing plug baffle seat 807, a second sealing plug 808, a spring baffle seat 809, a second memory spring 810 and a spring baffle 811. The first memory spring 806 sleeves the central rod 805, the second sealing plug baffle seat 807 is connected with the control tube joint 814, and the second sealing plug baffle seat 807 and the second sealing plug 808 are sealed by a baffle seat sealing ring 8071, so that the sealing performance can be enhanced. The spring baffle 811 is welded with the second sealing plug 808, and the second sealing plug 808 is in threaded connection with the central rod 805. One end of the second memory spring 810 is installed in the spring baffle 811, and the other end of the second memory spring 810 is connected with the spring baffle seat 809. The spring baffle seat 809 is in threaded connection with the control tube joint 814.

The heat transfer efficiency difference is large due to the difference of geothermal layer temperatures and conductivity coefficients. A constant hot water extraction temperature can be set for the hot water constant temperature control device 8 designed by the present disclosure according to different hot water application fields, and then the low-temperature water is extracted when being heated to the required temperature, so that the needs of hot water application in many fields can be met. At the same time, the problems such as temperature reduction of stratum and slow heat transfer after repeated heating in geothermal layers are solved, and the application field of geothermal layer heating without water is greatly widened. Because of the high temperature of underground hot rock, the difficulty in implementing electric power control technology is large. Compared with common electric power control, the hot water constant temperature control device 8 is simple in process and high in operability.

The present disclosure further provides a heat supply method using the heat supply device using an underground dry heat source, comprising the following steps:
S1, exploring the underground dry heat source: using a special heat source exploration tool to explore an underground dry heat source area;
S2, measuring the heat conductivity coefficient of hot dry rock: extracting samples from explored dry heat source rock strata, and experimentally testing the heat conductivity coefficient; and according to the measured heat conductivity coefficient of the dry heat source and the heat conductivity coefficient of the heat supply pipeline, calculating the heat required by unit mass of cold water to heat hot water to a certain temperature in combination with the temperature difference between cold water and hot water;
S3, drilling a well: according to the explored heat source area, determining the drilling depth (the well depth is appropriately 3000-5000 m), drilling a vertical well, and drilling a horizontal well section after reaching the dry-hot strata, wherein the drilling length of the horizontal section is 500-1000 m;
S4, determining the number of branch wells: according to the injection flow of cold water and the engineering size of the heat supply pipeline, determining the number and size of branch wells to be drilled by the calculated heat required by unit mass of cold water; and
S5, arranging the heat supply device: arranging the heat supply pipeline in the drilled well, placing the cold water supply device 1 on the ground outside the well, and placing the hot water suction pump 4 in the heat supply pipeline.

The working process is as follows.

The low-temperature cold water pushes the first sealing plug 701 down by gravity, the compression spring 703 is squeezed, and the cold water unidirectional flow control device 7 is opened. The cold water enters the second supporting tube 706 from the third supporting tube 707, and flows into the first supporting tube 705 through the annular flow port 7022 on the limiting baffle 702. At the moment, the cold water unidirectional flow control device 7 is in an open state. The hot water in the stratum is heated, and then the temperature and the pressure are increased. When the pressure is larger than the injection pressure of the cold water, the compression spring 703 extends to push the first sealing plug 701 upwards, and the cold water unidirectional flow control device 7 is in a closed state. The whole process has no influence on the upward movement of the hot water in the inner tube 3.

After the cold water is heated by the hot rock in the horizontal well heating section 9 and the branch well heating sections, the temperature is increased continuously. After the set temperature (for example, 85° C. for heating) suitable for ground application is reached, the hot water heat is quickly transferred into the special paraffin 803 contained inside by the moving block 804 made of copper. The paraffin 803 is heated and expanded, the telescopic rubber hose 812 is squeezed, and the compressed air 813 inside the telescopic rubber hose 812 is compressed to apply a rightward acting force to the push rod 802. Because the push rod 802 is fixed, a rightward counter-acting force is applied to the moving block 804. The moving block 804 is pushed to move leftwards, and then the central rod 805 and the second sealing plug 808 move leftwards. The control device is opened, the hot water enters the inner tube 3 of the horizontal well heating section 9, and finally the hot water is discharged to the ground by the hot water suction pump 4. With the continuous discharge of hot water and the continuous injection of cold water, the temperature of the stratum is decreased and the heat transfer gradually slows down. After the hot water temperature is lower than the set temperature, the special paraffin 803 inside the moving block 804 is contracted after the temperature is decreased, and the telescopic rubber hose 812 and the compressed air 813 inside the telescopic rubber hose 812 are expanded accordingly. The air pressure inside the telescopic rubber hose 812 is decreased. Under the combined action of the counter-acting force of the push rod 802 and the first memory spring 806 and the second memory spring 810, the moving block 804 moves rightwards, and the center rod 805 and the second sealing plug 808 are driven to move rightwards. When the second sealing plug 808 makes contact with the second sealing plug baffle seat 807, the control device is in a closed state. The hot water is no longer discharged. When the hot water is heated to a certain temperature, a next cycle is followed.

Finally, it should be noted that the foregoing embodiments are merely intended for describing the technical solutions of the present disclosure, but not for limiting the present disclosure. Although the present disclosure is described in detail with reference to the foregoing embodiments, a person of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. A heat supply device using an underground dry heat source, comprising a cold water supply device (1), a hot water suction pump (4) and a heat supply pipeline, wherein the cold water supply device (1) is arranged on the ground and used for injecting cold water into the heat supply pipeline; the hot water suction pump (4) is connected with the heat supply pipeline; and the heat supply pipeline comprises a vertical well conduction section and a horizontal well heating section (9).

2. The heat supply device using an underground dry heat source according to claim 1, wherein the heat supply pipeline further comprises a plurality of branch well heating sections respectively connected with the horizontal well heating section (9).

3. The heat supply device using an underground dry heat source according to claim 1, wherein the heat supply pipeline comprises an inner tube (3) and an outer tube (2), the inner tube (3) is arranged in the middle of the outer tube (2), and the inner tube (3) is a hot water channel (6); and a cold water channel (5) is formed between the inner tube (3) and the outer tube (2), the cold water supply device (1) injects cold water into the cold water channel (5), and the heated hot water is pumped out of the inner tube (3) by the hot water suction pump (4).

4. The heat supply device using an underground dry heat source according to claim 3, further comprising a cold water unidirectional flow control device (7), wherein the cold water unidirectional flow control device (7) is in threaded connection with the outer tube (2);
the cold water unidirectional flow control device (7) comprises a first sealing plug (701), a limiting baffle (702), a compression spring (703), a tube shoulder (704) and supporting tubes; the first sealing plug (701) sleeves the inner tube (3) and is in clearance fit with the inner tube (3), and the first sealing plug (701) and the supporting tubes are sealed by a conical sealing structure (7011); the limiting baffle (702) is welded with the supporting tubes as a whole and used for limiting the left-and-right torsion of the compression spring (703), and the limiting baffle (702) is provided with a limiting piece (7021) and a flow port (7022); the compression spring (703) is arranged between the first sealing plug (701) and the tube shoulder (704), and the tube shoulder (704) is in threaded connection with the inner tube (3); and the supporting tubes are in threaded connection with the outer tube (2).

5. The heat supply device using an underground dry heat source according to claim 4, wherein the supporting tubes comprise a first supporting tube (705), a second supporting tube (706) and a third supporting tube (707), the limiting baffle (702) is welded on the second supporting tube (706), and the two ends of the second supporting tube (706) are respectively welded and connected with the first supporting tube (705) and the third supporting tube (707); and the bottom of the first supporting tube (705) is in threaded connection with the outer tube (2), and the top of the third supporting tube (707) is in threaded connection with the outer tube (2).

6. The heat supply device using an underground dry heat source according to claim 4, further comprising a hot water constant temperature control device (8), wherein the hot water constant temperature control device (8) is in threaded connection with the inner tube (3).

7. The heat supply device using an underground dry heat source according to claim 6, wherein the hot water constant temperature control device (8) comprises a hollow fixed mount (801) and a control tube joint (814); one side of the control tube joint (814) is in threaded connection with the inner tube (3) of the horizontal well heating section (9), the other side of the control tube joint (814) is in threaded connection with the hollow fixed mount (801), and the hollow fixed mount (801) is in threaded connection with the inner tube (3) of the horizontal well heating section (9);
a push rod (802), a temperature control movable assembly and a sealing assembly are arranged in the control tube joint (814); one end of the push rod (802) is connected with the hollow fixed mount (801), and the other end of the push rod (802) is in clearance fit with the temperature control movable assembly; and the sealing assembly is connected with the temperature control movable assembly and is in threaded connection with the control tube joint (814).

8. The heat supply device using an underground dry heat source according to claim 7, wherein the temperature control movable assembly comprises a moving block (804) and a central rod (805); one end of the push rod (802) extends into the port of the moving block (804) to form a clearance fit with the moving block (804); a cavity is formed in the interior of the moving block (804), the cavity is filled with paraffin (803), a telescopic rubber hose (812) is arranged in the cavity, and a proper amount of compressed air (813) is injected into the telescopic rubber hose (812); and one end of the central rod (805) is in threaded connection with the moving block (804).

9. The heat supply device using an underground dry heat source according to claim 8, wherein the sealing assembly comprises a first memory spring (806), a second sealing plug baffle seat (807), a second sealing plug (808), a spring baffle seat (809), a second memory spring (810) and a spring baffle (811); the first memory spring (806) sleeves the central rod (805), the second sealing plug baffle seat (807) is connected with the control tube joint (814), and the second sealing plug baffle seat (807) and the second sealing plug (808) are sealed by a baffle seat sealing ring (8071); the spring baffle (811) is welded with the second sealing plug (808), and the second sealing plug (808) is in threaded connection with the central rod (805); one end of the second memory spring (810) is installed in the spring baffle (811), and the other end of the second memory spring (810) is connected with the spring baffle seat (809); and the spring baffle seat (809) is in threaded connection with the control tube joint (814).

10. A heat supply method using the heat supply device using an underground dry heat source according to claim 1, comprising the following steps:
S1, exploring the underground dry heat source: using a special heat source exploration tool to explore an underground dry heat source area;
S2, measuring the heat conductivity coefficient of hot dry rock: extracting samples from explored dry heat source rock strata, and experimentally testing the heat conductivity coefficient; and according to the measured heat conductivity coefficient of the dry heat source and the heat conductivity coefficient of the heat supply pipeline, calculating the heat required by unit mass of cold water to heat hot water to a certain temperature in combination with the temperature difference between cold water and hot water;
S3, drilling a well: according to the explored heat source area, determining the drilling depth, drilling a vertical well, and drilling a horizontal well section after reaching the dry-hot strata;
S4, determining the number of branch wells: according to the injection flow of cold water and the engineering size of the heat supply pipeline, determining the number and size of branch wells to be drilled by the calculated heat required by unit mass of cold water; and
S5, arranging the heat supply device: arranging the heat supply pipeline in the drilled well, placing the cold water supply device (1) on the ground outside the well, and placing the hot water suction pump (4) in the heat supply pipeline.

11. The heat supply method according to claim 10, wherein the heat supply pipeline further comprises a plurality of branch well heating sections respectively connected with the horizontal well heating section (9).

12. The heat supply method according to claim 10, wherein the heat supply pipeline comprises an inner tube (3) and an outer tube (2), the inner tube (3) is arranged in the middle of the outer tube (2), and the inner tube (3) is a hot water channel (6); and a cold water channel (5) is formed between the inner tube (3) and the outer tube (2), the cold water supply device (1) injects cold water into the cold water channel (5), and the heated hot water is pumped out of the inner tube (3) by the hot water suction pump (4).

13. The heat supply method according to claim 12, further comprising a cold water unidirectional flow control device (7), wherein the cold water unidirectional flow control device (7) is in threaded connection with the outer tube (2);
the cold water unidirectional flow control device (7) comprises a first sealing plug (701), a limiting baffle (702), a compression spring (703), a tube shoulder (704) and supporting tubes; the first sealing plug (701) sleeves the inner tube (3) and is in clearance fit with the inner tube (3), and the first sealing plug (701) and the supporting tubes are sealed by a conical sealing structure (7011); the limiting baffle (702) is welded with the supporting tubes as a whole and used for limiting the left-and-right torsion of the compression spring (703), and the limiting baffle (702) is provided with a limiting piece (7021) and a flow port (7022); the compression spring (703) is arranged between the first sealing plug (701) and the tube shoulder (704), and the tube shoulder (704) is in threaded connection with the inner tube (3); and the supporting tubes are in threaded connection with the outer tube (2).

14. The heat supply method according to claim 13, wherein the supporting tubes comprise a first supporting tube (705), a second supporting tube (706) and a third supporting tube (707), the limiting baffle (702) is welded on the second supporting tube (706), and the two ends of the second supporting tube (706) are respectively welded and connected with the first supporting tube (705) and the third supporting tube (707); and the bottom of the first supporting tube (705) is in threaded connection with the outer tube (2), and the top of the third supporting tube (707) is in threaded connection with the outer tube (2).

15. The heat supply method according to claim 13, further comprising a hot water constant temperature control device (8), wherein the hot water constant temperature control device (8) is in threaded connection with the inner tube (3).

16. The heat supply method according to claim 15, wherein the hot water constant temperature control device (8) comprises a hollow fixed mount (801) and a control tube joint (814); one side of the control tube joint (814) is in threaded connection with the inner tube (3) of the horizontal well heating section (9), the other side of the control tube joint (814) is in threaded connection with the hollow fixed mount (801), and the hollow fixed mount (801) is in threaded connection with the inner tube (3) of the horizontal well heating section (9);
a push rod (802), a temperature control movable assembly and a sealing assembly are arranged in the control tube joint (814); one end of the push rod (802) is connected with the hollow fixed mount (801), and the other end of the push rod (802) is in clearance fit with the temperature control movable assembly; and the sealing assembly is connected with the temperature control movable assembly and is in threaded connection with the control tube joint (814).

17. The heat supply method according to claim 16, wherein the temperature control movable assembly comprises a moving block (804) and a central rod (805); one end of the push rod (802) extends into the port of the moving block (804) to form a clearance fit with the moving block (804); a cavity is formed in the interior of the moving block (804), the cavity is filled with paraffin (803), a telescopic rubber hose (812) is arranged in the cavity, and a proper amount of compressed air (813) is injected into the telescopic rubber hose (812); and one end of the central rod (805) is in threaded connection with the moving block (804).

18. The heat supply method according to claim 17, wherein the sealing assembly comprises a first memory spring (806), a second sealing plug baffle seat (807), a second sealing plug (808), a spring baffle seat (809), a second memory spring (810) and a spring baffle (811); the first memory spring (806) sleeves the central rod (805), the second sealing plug baffle seat (807) is connected with the control tube joint (814), and the second sealing plug baffle seat (807) and the second sealing plug (808) are sealed by a baffle seat sealing ring (8071); the spring baffle (811) is welded with the second sealing plug (808), and the second sealing plug (808) is in threaded connection with the central rod (805); one end of the second memory spring (810) is installed in the spring baffle (811), and the other end of the second memory spring (810) is connected with the spring baffle seat (809); and the spring baffle seat (809) is in threaded connection with the control tube joint (814).
